(19) United States
(12) Patent Application Publication
(10) Pub. No.: US 2009/0186598 A1
(43) Pub. Date: Jul. 23, 2009

(54) Automatic Step-Down of Prepaid Accounts for Communication Services

(76) Inventors: Daniel Cipoletti, (US); Sherilyn Dwyer, (US); John Karsner, Benicia, CA (US); James Gamm, (US)

Correspondence Address: FENWICK & WEST LLP, SILICON VALLEY CENTER, 801 CALIFORNIA STREET, MOUNTAIN VIEW, CA, 94041, US

(21) Appl. No.: 12/018,719

(22) Filed: Jan. 23, 2008

(51) Int. Cl. H04M 11/00

(52) U.S. Cl. 455/406

(57) ABSTRACT

Subscribers of a wireless communication service may select from a number of bundled service plans, wherein a recurring charge is paid from prepaid accounts by the subscribers in exchange for a bundled package of services. If a subscriber does not have sufficient value in the subscriber's account to pay the recurring charge for the selected bundled service plan, the subscriber's account is automatically stepped down to a different plan that includes fewer or no bundled services and that may charge more per use of the services. If the subscriber subsequently adds sufficient funds to the account to pay for the originally selected service plan, the subscriber may be re-enrolled in that originally selected bundled service plan.

### BACKGROUND

1. Field of the Invention

This invention relates generally to communication services, such as prepaid wireless services, and more particularly to automatically adjusting the plan enrollment of a prepaid account for a subscriber of the communication service.

2. Background of the Invention

Many communication service providers—both wireless and wired—offer prepaid plans to their subscribers. But the way these plans are managed varies widely. When these plans are not managed effectively, profitability risks can be significant. Several service providers resort to price-only competitive strategies to attract new subscribers. For example, they may acquire new subscribers by offering price incentives such as free minutes or free or discounted handsets. This causes the service providers to bear new subscriber acquisition costs, which drives down the average revenue per unit of the subscriber base.

There is also a high churn rate associated with prepaid plans because service providers typically offer subscribers a limited set of plan options with very rigid rules. Often, these rules not only lock subscribers to a selected plan, but also penalize them for any payment defaults. The problem of high churn rate is compounded by the fact that several service providers only offer a single prepaid plan, which does not suit the needs of every new subscriber.

When a subscriber fails to pay the recurring charge for their prepaid account, and if the subscriber does not restore that account on time, service providers typically terminate the subscriber's service and cancel the subscriber's phone number. This may cause the subscriber to forfeit any balance money left in the prepaid account. Such an unfriendly attitude toward subscribers further alienates subscribers and discourages subscribers from signing on to the prepaid plan. In view of these deficiencies, flexibility in the choice of prepaid plans, as well as a more graceful handling of situations where subscribers fail to pay the charges on time, are needed to curb the high churn rates typically observed with subscribers of prepaid communication services.

Accordingly, there exists a need for a mechanism that allows subscribers of communication services to choose a suitable prepaid plan while avoiding the limitations of existing systems described above.

### SUMMARY OF THE INVENTION

To meet the needs of consumers as well as those of service providers, a billing system is configured to adjust a subscriber's prepaid account when the subscriber fails to meet certain minimum prepayment criteria. The adjustment to a subscriber's account may be to switch the subscriber's account from a more expensive option to a less expensive option, thereby enabling the subscriber to continue accessing the services. The less expensive option would typically include fewer communication services, but those services may be more expensive on a per-unit basis that the services in the more expensive option. For example, a more expensive option may include a larger number of bundled minutes of talk time, which costs more as a bundle but less on a per-minute basis. Essentially, the subscriber is buying fewer services but paying more for them on a per-unit basis. The additional profit on the services offsets the loss due to the lesser amount of services purchased. The subscriber thus continues to have access to the communications services, and the service provider is able to keep its customer.

In one type of prepaid account for wireless communications services, subscribers select from one or more bundled plans in which each subscriber prepays for a bundled set of services (e.g., minutes of talk time, kilobytes of data downloads, number of text messages, etc.) each month. The subscriber's account is debited each month to buy the bundle of services for the next month according to the subscriber's selected plan. Typically, if a subscriber has insufficient funds in the prepaid account to purchase the selected bundle of services for the following month, the account is deactivated. To avoid this, embodiments of the invention automatically step the subscriber's account down to a less expensive bundled plan if the subscriber has sufficient funds for that less expensive plan. This allows the subscriber to continue using the services even when the subscriber's prepaid account is insufficient to support the selected service plan.

In one embodiment, the service provider automatically cures the subscriber's account by returning it to the original status (i.e., the originally selected bundled plan) if the subscriber subsequently adds a sufficient value to the account.

These and other features, aspects, and advantages of various embodiments of the invention will become better understood with regard to the following description and accompanying drawings.

### BRIEF DESCRIPTION OF THE DRAWINGS

FIG. 1 is a schematic diagram of a wireless telephone services system, in accordance with an embodiment of the invention.

FIG. 2 shows a portion of a record in a subscriber database, in accordance with an embodiment of the invention.

FIG. 3 is a flow diagram of a process for automatically stepping down a subscriber's prepaid account to a less expensive service plan, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

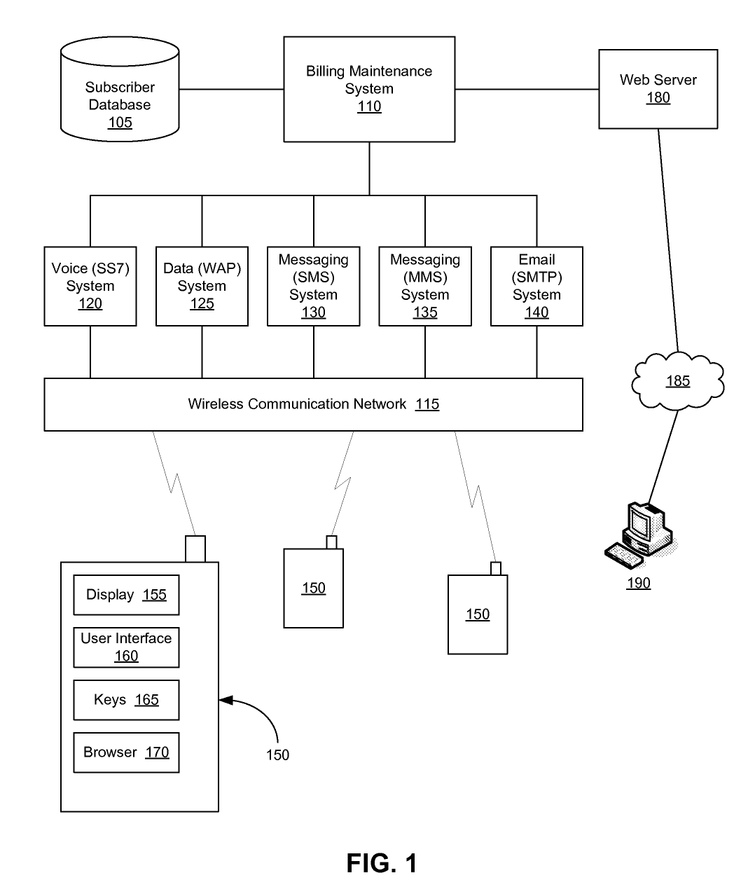

The automatic step-down functionality described herein may be applied to many different types of telephone services, including both wired and wireless telephone services. Each of these types of telephone services may be implemented using a variety of hardware and software architectures. FIG. 1 shows one example of a system for providing wireless communication services; however, embodiments of the invention are not limited to this particular architecture or combination of wireless services shown, but rather they can be applied in many other environments. Accordingly, the architecture of a wireless services system is described herein to provide a context for an implementation of various embodiments of the methods and services described herein, but not to limit the applicability of those embodiments.

In a basic scenario, subscribers use their wireless mobile devices 150 to communicate with the services system via a wireless communications network 115. The wireless services system shown in FIG. 1 includes a number of subsystems that provide services for the subscribers. In this example, the subsystems include a voice system 120 to allow subscribers to make voice calls via the wireless network 115 and a data system 125 to allow subscribers to access digital information over the network 115 from their wireless devices 150. The wireless services system may further include subsystems such as a text messaging system 130, multimedia messaging system 135, and an email system 140, enabling subscribers to send various types of asynchronous messages over the network 115. These and other types of wireless services are well known.

The wireless service provider may track the subscribers' use of the services using a billing maintenance system 110. The billing maintenance system 110 typically comprises a computer system having software for managing the subscriber accounts for the wireless service. The billing maintenance system 110 is coupled to a subscriber database 105, which stores entries for the subscribers' accounts. In one illustrative example, the data associated with a subscriber's account includes a unique identification number (such as the phone number for the wireless device), a status for the subscriber's account (e.g., current, past due, suspended, or expired), an access code for validation of the subscriber, an account balance, and an optional expiration date of the account (defined below).

The billing maintenance system 110 is communicatively coupled to the services subsystems 120 through 140 to monitor their usage. In this way, the billing maintenance system 110 can record the transaction data for each subscriber in the subscriber database 105. The transaction data is an account of each subscriber's use of the services, which may for example include data such as the minutes and other details of voice calls, the amount of data sent and/or received in messages and emails, and the purchases of games or ring tones. As subscriber usage activity occurs, or periodically at other times, the billing maintenance system 110 adjusts the subscribers' account balances in the subscriber database 105 to debit the accounts for that usage as appropriate. The billing maintenance system 110 preferably also logs the usage activity in the subscriber database 105 so it can be later reported, for example, for billing or accounting purposes.

As shown in FIG. 1, the wireless devices 150 operated by the subscribers are configured to communicate wirelessly with the wireless communications network 115. Many types of wireless devices 150 exist, and other types will likely be developed in the future, but the devices 150 may comprise any products capable of communicating with the wireless network 115 described herein. This includes cellular phones, PDAs, handheld email devices, and similar devices.

In a typical embodiment, the wireless communication device 150 comprises a display 155, a user interface 160 for causing the display 155 to show content to a subscriber, and keys 165 to allow a subscriber to input controls and information. The keys 165 may include a first group of keys in the form of hard-coded keys (such as alphanumeric keys) and a second group of keys in the form of operation keys or “soft keys.” In one embodiment, the wireless device 150 further includes a browser 170 (such as a WAP browser or “minibrowser”) for viewing digital content encoded in a markup language.

The wireless service may be offered as a prepaid service, in which subscribers add value to their accounts before using the network. In one example of a prepaid service, the billing maintenance system 110 maintains the balance information for each of the subscribers, where the balance information includes an amount of value remaining in each subscriber's account. Based on pricing schemes defined by the service provider, a subscriber's usage of the network and/or other purchases associated with the subscriber's account causes a corresponding debiting of that account. The subscriber can continue to use the services while there is sufficient value in the account, after which the subscriber must add value to the account (also known as “topping up”). A variety of different payment methods may be used to replenish a prepaid account, including, without limitation, credit or debit card payments, direct payment from a checking account, and purchase and use of a PIN. Further, an expiration date may be set for each subscriber account, after which the account becomes inactive unless the subscriber adds value to the account. This date is typically set to be several months after the last time value was added to the account, or alternatively, after the last activity charged to the account.

In the context of a prepaid wireless services system shown in FIG. 1, and/or for other types of telephone services, a telephone service provider may offer a subscriber a choice among various payment plans. A subscriber may select one of many bundled service plans with each bundled service plan having a recurring charge associated with it for each payment cycle. The subscriber has several ways to choose a bundled service plan. For example, the web server 180 may receive a subscriber selection for a bundled service plan or for receiving payment to increase the subscriber's account balance. The web server 180 may be coupled to the billing maintenance system 110. Alternately, the subscriber may select a bundled service plan via the Internet 185, e.g., from a personal computer 190 that contacts the telephone service provider via the web server 180.

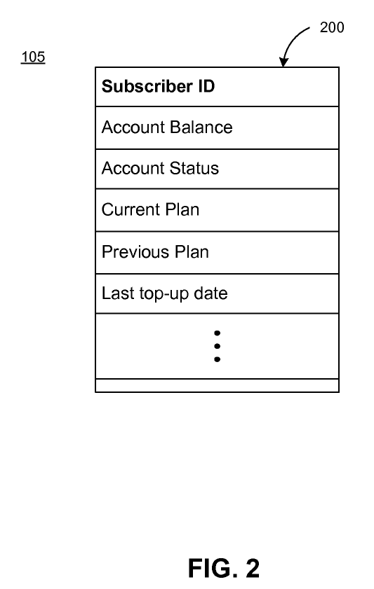

Once a subscriber selects a plan, the billing and maintenance system 110 stores this information in the subscriber database 105. FIG. 2 illustrates a sample record 200 in the subscriber database 105 for storing a subscriber's information. In the example shown, the data record 200 includes an account balance indicating the remaining balance for the subscriber's prepaid account; an account status indicating whether the account is active; a current service plan in which the subscriber is enrolled (e.g., a bundled plan or a basic per-use plan); a previous service plan indicating a previously selected plan (e.g., in the event the service provider automatically changes the subscriber's plan from the subscriber's originally selected plan); and a last top-up date indicating when the subscriber last added value to the prepaid account.

The subscriber database 105 is updated in response to any events that trigger updates in of the records 200 associated with any subscriber. For example, a subscriber may enroll in a selected bundled service plan and then add value to the prepaid account. In such a case, the account balance is updated, the current plan is set to the selected bundled service plan, and the last top-up date is set to the date on which the funds were added to the prepaid account. Subsequently, when the subscriber adds value to the prepaid account, the account balance is updated and the last top-up date is set to the date on which the funds were added to the prepaid account.

For a given payment cycle, the telephone service provider via the billing maintenance system 110 normally debits the subscriber's account by the recurring charge amount associated with the selected bundled service plan. If there is sufficient balance in the subscriber's prepaid account for the selected bundled service plan and the subscriber was enrolled in the selected bundled service plan, the account is debited for the new payment cycle, and the account balance is updated. However, if there is insufficient balance in the prepaid account for the selected bundled service plan in which the subscriber was enrolled, the subscriber is switched to a different service plan. The subscriber's account is then debited for the new payment cycle based on the recurring charge—if any—for the new service plan. The subscriber's account is also debited according to a rate associated with this new plan upon the subscriber's use of services.

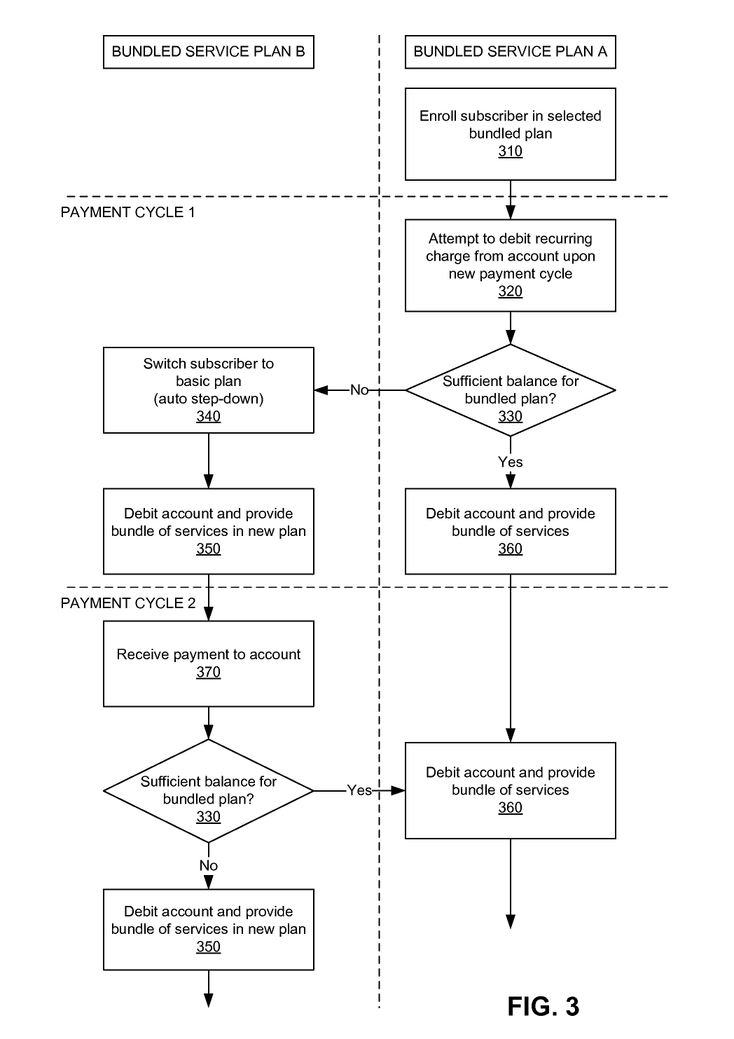

FIG. 3 is a flow diagram of a process for adjusting the status of a subscriber's prepaid account, in accordance with one embodiment of the invention. As illustrated, the subscriber is first enrolled 310 in a selected bundled service plan. In the next payment cycle, the billing maintenance system 110 attempts 320 to debit the recurring charge from the prepaid account associated with the selected bundled service plan. The billing maintenance system 110 then determines 330 if there is sufficient balance in the prepaid account for payment of the recurring charge for the selected bundled service plan. If there is sufficient balance, the billing maintenance system 110 debits 360 the account and provides the subscriber with the bundle of services associate with the selected bundled service plan. If there is insufficient balance, however, the billing maintenance system 110 switches 340 the subscriber to the basic service plan and updates the corresponding information in the subscriber database 105. Upon being switched to the basic service plan, the billing maintenance system 110 debits 350 the subscriber's account according to the new plan.

In one embodiment, the subscriber's account is stepped down to a basic service plan, which includes no bundled services and charges more per use of the services than any of the bundled plans. Typically, because the services have not been pre-purchased for the given time period (e.g., month), the basic service plan offers the services at a higher use rate. If the subscriber is switched to the basic service plan, the billing maintenance system 110 begins to debit the subscriber's account based on the pricing scheme in the basic service plan. As long as the subscriber has some funds in the account, the subscriber can continue to use the services—albeit at a higher rate. In another embodiment, the subscriber's account is stepped down to a different bundled service plan that includes fewer bundled services but charges more per use of the services than the subscriber's originally selected service plan.

The billing system 110 may determine the service plan to which the subscriber's account is stepped down by selecting the most expensive bundled service plan that the subscriber's account balance can afford. In this way, the subscriber has as many bundled services as the prepaid account can support, but a lesser amount because the account does not have a sufficient balance to purchase the services in the selected bundled service plan. If the subscriber's account balance cannot support any of the available bundled service plans, the account may be stepped down to the basic service plan.

In one embodiment, the billing system 110 may allow the subscriber to cure the problem that lead to the automatic stepping down of the subscriber's account to a less expensive service plan. For example, as shown in FIG. 3, the billing maintenance system 110 may receive 370 a payment from the subscriber for the prepaid account. The billing maintenance system 110 then determines 330 if there is sufficient balance in the prepaid account for payment of the recurring charge for the originally selected bundled service plan. If there is sufficient balance, the billing maintenance system 110 re-enrolls 390 the subscriber back in the originally selected bundled service plan for the payment cycle and updates the corresponding information in the subscriber database 105. If there is not a sufficient balance to re-enroll the subscriber in the original service plan, the subscriber remains in the stepped-down service plan. The billing maintenance system 110 thus debits 350 the subscriber's account and provides the services according to the same stepped-down plan.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above teachings.

Some portions of above description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, these arrangements of operations may be referred to as modules, without loss of generality. The described operations and their associated modules may be embodied in software, firmware, hardware, or any combinations thereof.

In addition, the terms used to describe various quantities, data values, and computations are understood to be associated with the appropriate physical quantities and are merely convenient labels applied to these quantities. Unless specifically stated otherwise as apparent from the following discussion, terms such as “processing” or “computing” or “calculating” or “determining” or the like refer to the action and processes of a computer system or similar electronic computing device, which manipulates and transforms data represented as physical (e.g., electronic) quantities within the computer system memories or registers or other such information storage, transmission, or display devices.

Embodiments of the invention may also relate to an apparatus for performing the operations herein. This apparatus may be specially constructed for the required purposes, or it may comprise a general-purpose computing device selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium and modulated or otherwise encoded in a carrier wave transmitted according to any suitable transmission method.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, embodiments of the invention are not described with reference to any particular programming language. It is appreciated that a variety of programming languages may be used to implement various embodiments of the invention as described herein, and any references to specific languages are provided for disclosure of enablement and best mode of embodiments of the invention.

Finally, it should be noted that the language used in the specification has been principally selected for readability and instructional purposes, and it may not have been selected to delineate or circumscribe the inventive subject matter. Accordingly, the disclosure of the embodiments of the invention is intended to be illustrative, but not limiting, of the scope of the invention, which is set forth in the following claims.

What is claimed is:

1. A method for automatically switching the plan enrollment of a prepaid account for communication services, the method comprising:
maintaining a prepaid account for a subscriber of communication services, the prepaid account having an account balance to which the subscriber can add value;
offering a plurality of service plans to the subscriber, the service plans offering varying amounts of bundled services;
enrolling the subscriber in one of the service plans based on a selection received from the subscriber, the selected service plan being a bundled service plan debiting the subscriber's account by a recurring charge amount for each payment cycle in exchange for a bundled set of wireless communication services for the payment cycle; and
responsive to the subscriber's account having insufficient funds to pay the recurring charge for the selected service plan, switching the subscriber to a different one of the service plans having a lower or no recurring charge and for which the subscriber's account contains sufficient funds.

2. The method of claim 1, wherein the service plans comprise:
a basic service plan in which the subscriber's account is debited by a basic rate for the subscriber's use of the wireless communication services, and
a plurality of bundled service plans, each bundled service plan debiting the subscriber's account by a recurring charge amount for each payment cycle in exchange for a bundled set of wireless communication services for the payment cycle.

3. The method of claim 2, wherein the subscriber's account is switched to the basic service plan responsive to the subscriber's account having insufficient funds to pay the recurring charge for the selected service plan.

4. The method of claim 1, wherein the subscriber's account is switched to a service plan that charges more per use of the services responsive to the subscriber's account having insufficient funds to pay the recurring charge for the selected service plan.

5. The method of claim 1, wherein the communication services comprises wireless communication services.

6. The method of claim 1, further comprising:
after switching the subscriber's account to the difference service plan, receiving a payment from the subscriber to add value to the account; and
if the subscriber has sufficient funds to pay the recurring charge for the service plan according to the subscriber's selection, switching the subscriber back to the service plan according to the subscriber's selection.

7. A wireless communication services system for automatically switching the plan enrollment of prepaid accounts for wireless communication services, the system comprising:
a wireless communication network interface for allowing the subscribers of the wireless communication service provider to engage in wireless communications after enrolling in one of a plurality of service plans;
a subscriber database configured to maintain a prepaid account for each subscriber of the communication services, each prepaid account having an account balance to which the subscriber can add value; and
a billing maintenance system configured to receiving payments for the subscribers' accounts and to determine whether value has been added to the accounts within a predetermined time period, the billing maintenance system further configured to switch any subscriber accounts to which value has not been added within the predetermine time period to a different one of the service plans that includes fewer or no bundled services if the accounts.

7. The system of claim 7, wherein the wireless communication services comprise one or more of voice services, data services, and messaging services.

8. The system of claim 7, further comprising:
a web server for receiving payments from subscribers to add value to the subscribers' accounts.

9. The system of claim 7, wherein the service plans comprise:
a basic service plan in which the subscriber's account is debited by a basic rate for the subscriber's use of the wireless communication services, and
a plurality of bundled service plans, each bundled service plan debiting the subscriber's account by a recurring charge amount for each payment cycle in exchange for a bundled set of wireless communication services for the payment cycle.

10. The system of claim 9, wherein the billing maintenance system is configured to switch subscribers' accounts to the basic service plan responsive to the accounts' having insufficient funds to pay the recurring charge.

11. The system of claim 7, wherein the billing maintenance system is configured to switch subscribers' accounts to a service plan that charges more per use of the services responsive to the accounts' having insufficient funds to pay the recurring charge.

12. The system of claim 7, wherein the billing maintenance system is further configured to switch a subscriber's account back to the subscriber's selected service plan upon receiving a payment from the subscriber to add sufficient value in the account to pay the recurring charge for the selected service plan.
